(19) United States
(12) Patent Application Publication
(10) Pub. No.: US 2019/0100349 A1
(43) Pub. Date: Apr. 4, 2019

(54) DEVICE FOR TRANSPORTING PIECE GOODS AND CONTAINERS

(71) Applicant: WRH WALTER REIST HOLDING AG, CH-8272 ERMATINGEN (CH)

(72) Inventor: Carl Conrad MÄDER, Hittnau (CH)

(73) Assignee: WRH WALTER REIST HOLDING AG, CH-8272 ERMATINGEN (CH)

(21) Appl. No.: 16/145,972

(22) Filed: Sep. 28, 2018

(30) Foreign Application Priority Data
Sep. 29, 2017 (CH) 01194/17

(51) Int. Cl. B65D 19/00; B65D 71/70

(52) U.S. Cl. CPC B65D 19/0002; B65D 19/0044; B65G 2201/0258; B65D 2519/00303; B65D 71/70

(57) ABSTRACT

A transport carrier for transport of transport goods includes a transport carrier structure for carrying the transport goods on a horizontal plane of the transport carrier, having a top side, which defines the plane of the transport carrier, and a bottom side; and a retaining structure arranged on the top side of the transport carrier structure for restricting or preventing a horizontal movement of transport goods supported on the transport carrier structure with respect to the plane of the transport carrier. The retaining structure includes means which interact with bearing elements of the aforementioned transport goods standing on the transport carrier structure and thus cause a reversible fixation of the transport goods along at least one vector parallel to the plane of the transport carrier, such that a force which exceeds a certain threshold level must be expended parallel to the plane of the transport carrier to overcome said fixation.

### CROSS-REFERENCE TO RELATED APPLICATIONS

Swiss Patent Application 01194/17, filed 29 Sep. 2017, the priority document corresponding to this invention, to which a foreign priority benefit is claimed under Title 35, United States Code, Section 119, and its entire teachings are incorporated, by reference, into this specification.

### BACKGROUND OF THE INVENTION

### Field of the Invention

The present invention relates to transport carriers for transport of transport goods, in particular piece goods and rollable as well as non-rollable containers, having a transport carrier structure for carrying the transport goods in the plane of the transport carrier, as well as a method for loading a transport carrier.

### Discussion of Related Art

In intralogistics systems, transport goods such as piece goods or containers are often conveyed along a transport line, added to or removed from storage in corresponding storage systems, transferred to interfaces such as trucks to other transport systems or handed over to them, etc. Such intralogistics systems may serve various purposes, for example, management of storage, commissioning of orders or shipping of intermediate products and the like in production chains. For efficiency reasons, it is desirable to carry out such transport processes and handling processes as automatically as possible and in the smallest possible number of steps.

One problem with such transport and handling processes may be the irregularity of the transport goods to be processed. Therefore, various transport carriers on or in which the transport goods are stored, so that the transport carriers containing the transport goods can be transported or handled easily are known from the prior art. For example, shipments of goods made available and transported on standardized pallets, such as Euro pallets for the European Pallet Pool. Such standardized pallets can be transported automatically using corresponding automated equipment or can be put into and/or removed from storage systems.

For reasons of cost, because of the globalization of trade, and also for regulatory purposes, standard pallets and similar systems are being used much less often today. Instead of that, single-use transport carriers, which are manufactured inexpensively and have a low stability accordingly, are being used. For example, such transport carriers may have only block-type feet instead of the Euro pallet feet, which are continuous in the longitudinal direction. The transport carriers may even be manufactured from less stable but inexpensive cardboard elements. However, the low mechanical stability and the dimensional variety make transport and automatic handling more difficult.

EP 2639188 A1 discloses an automated storage system for packages and piece goods, in which these are removed from pallets and placed individually on a transport carrier for storage goods in the form of a tray with a peripheral edge and then sent together with this to the warehouse system. Since the goods to be stored have a base area that is essentially the same as that of the tray, the goods are held on the tray in a form-fitting manner by the peripheral edge in the horizontal direction.

WO 2015/090369 A1 discloses a transport carrier for warehouse goods for a warehouse lift system having a frame and a bottom attached to the frame, wherein the frame forms a peripheral edge with respect to the bottom. The transport goods are held in a form-fitting manner by the edge in the horizontal direction.

Secure horizontal fixation of the transport goods on the transport carriers' presupposes that the shape of the transport goods and the transport carrier are coordinated with one another because otherwise the transport goods could still be displaced horizontally within the available volume despite the form-fitting connection. This can result in damage to the transport goods or transport carriers and/or to problems in process sequences and installations in the case of larger or heavier transport goods or fast conveyor processes.

DE 202014108207 A1 discloses a transport container for automated transport of letters and packages in a distributor system. A flat bottom is arranged obliquely in a shallow rectangular frame. With a horizontal alignment of the frame, a package or letter will slip down on the oblique bottom due to gravity until it reaches the protruding frame and is then held in a form-fitting manner in the transport container. The frame is tilted to empty the transport container, so that the transport goods slip out of the transport carrier on the bottom.

DE 202014104805 U1 discloses another transport container for automated transport of transport goods. A flat bottom is inserted into a low rectangular frame, so that the frame forms a peripheral edge. The bottom can be raised inside the frame, so that the flat bottom is flush with the frame and then no edge remains. This permits loading and unloading of the transport container at ground level without allowing the transport goods to fall into the container or having to be removed from it. A similar system is also known from DE 102008026326 A1.

To be able to contain rollable transport goods, for example, airplane service trolleys, carts, etc., on transport carriers in automated systems, and because of their inherent easy mobility, such rollable transport goods are secured with form-fitting means, for example brake pads, or their wheels or rollers are blocked.

DE 102015217958 A1 describes an automated parking garage, in which a vehicle is parked by a user in a transfer station on a storage platform. Then the storage platform including the vehicle is conveyed by means of transport lifts, displacement devices and a plurality of conveyor belts to certain storage location. The vehicle must be secured at least with the parking brake for secure transport.

There is a general need for improvements in this field.

### SUMMARY OF THE INVENTION

The object of the invention is to make available a transport carrier of the type defined in the introduction, which does not have at least some of the disadvantages mentioned above and other disadvantages.

In particular such a transport carrier should allow efficient transport of various transport goods in a transport system, in particular a conveyor system and/or a storage system.

In addition, such a transport carrier should be long-lived and stable as well as being inexpensive to manufacture and efficient to maintain.

Another object of the invention is to provide an efficient method for loading a transport carrier according to the invention.

These and other objects are achieved by a transport carrier according to the invention, and by a method according to the invention, respectively, according to the independent claims. Other advantageous embodiments are defined in the dependent claims.

The approach according to the invention can be further improved by various embodiments, each of which is advantageous per se and can be combined with another one as desired, unless otherwise indicated. These embodiments and the advantages associated with them are described in detail below.

Within the context of this description, the term transport goods should comprise in general objects that can be transported or handled individually, in particular piece goods with or without packaging but also other rollable and non-rollable transport carriers and containers such as pallets and supporting structures, luggage pieces such as for example suitcases, bags and baskets, crates, packages, rollable trolleys, carts, rollable stands and platforms with or without a load.

A first aspect of the invention relates to an advantageous transport carrier for transport of transport goods, comprising a transport carrier structure for carrying the transport goods on a horizontal plane of the transport carrier, with a top side, which defines the plane of the transport carrier, and a bottom side; and a retaining structure arranged on the top side of the transport carrier structure for restricting or preventing a horizontal movement of a transport good stored on the transport structure with respect to the plane of the transport carrier.

The retaining structure has means which interact with storage elements of the aforementioned transport goods standing on the transport carrier structure and thereby establish reversible means of securing the transport goods along at least one vector parallel to the plane of the transport carrier, such that a force exceeding a certain threshold level must be applied acting parallel to the plane of the transport carrier to overcome this fixation.

In this description, a direction parallel to the plane of the transport carrier is also referred to as horizontal.

Compared to a conventional conveying system, such as for example a belt conveyor or a roller conveyor, a transport carrier according to the inventions allows more flexible conveying and other handling of transport goods. A transport carrier according to the invention, and thus also the transport goods stored on them, may for example be conveyed individually, on their own and independent from other transport carriers.

During conveying, the transport carriers can be moved in all three directions in space, thus, not only horizontally, but also vertically. In addition to be moved along the spatial axes, transport carriers according to the invention may also be rotated. The transport carriers may for example be rotated about the vertical axis, or they can be tilted or pivoted about a horizontal axis.

With transport carriers according to the invention, logistic systems can be realized in which the transport goods on the transport carriers may not only be conveyed, but also can be sorted, stored, buffered, commissioned, or automatically loaded or unloaded.

With a transport carrier according to the invention, the retaining structure advantageously has means which increase the adhesive friction with respect to a smooth surface.

The top side of the transport carrier structure of a transport carrier according to the invention is advantageously at least as large as or larger than the projection of transport goods stored on the transport carrier structure perpendicular to the plane of the transport carrier.

The retaining structure advantageously secures transport goods stored on the transport carrier structure in a non-form-fitting manner parallel to the plane of the transport carrier.

In an advantageous embodiment variant of a transport carrier according to the invention, the retaining structure is a coating with a polymer having a high adhesive friction, a mat of elastic polymer, a brush mat, a mat with cavities, a carpet or combinations thereof.

The retaining structure may be embodied as a coating on a surface that increases the adhesive friction and/or rolling friction of rollable or non-rollable transport goods stored thereon.

For example, the top side of the transport carrier may be embodied as a sheet metal plate furnished with a coating of silicone rubber or acrylic rubber. If the transport goods, for example, piece goods with feet arranged beneath them, or a rollable trolley or cart is/are placed on the transport carrier, the resulting adhesive friction and/or rolling friction is sufficient to prevent sliding and/or rolling of the transport goods up to a certain threshold level of a force acting horizontally. The corresponding threshold level for the horizontal force depends on the coefficient of adhesive friction and/or the coefficient of rolling resistance, which in turn depend(s) on the specific pairing between the material properties of the top side of the transport carrier and the feet and/or wheels or rollers on the transport goods as well as the force acting on the plane of the transport carrier due to the weight of the transport goods.

The horizontal forces acting on the transport goods to be expected in normal operation of a conveyor system and/or a storage system depend first on the speed of the conveyor and the geometry of the conveyor path and/or on the positive or negative acceleration during transport and second on the weight of the transport goods. The coating on the top side of the transport carrier must therefore be selected so that the coefficient of adhesion and/or the coefficient of rolling resistance for all transport goods to be conveyed is/are such that a centrifugal force and/or an acceleration force acting horizontally cannot exceed the counteracting maximum force of adhesive friction and/or force of rolling resistance.

Therefore, the transport goods are not displaced in the horizontal direction during operation of a conveyor system such as that provided here with such transport carriers according to the invention. Therefore, no additional means of securing the transport goods on the transport carrier are necessary. The transport goods need not be secured in a form-fitting manner and/or it is not necessary to activate braking devices on rollable transport goods. This allows efficient loading and/or unloading of the transport carrier according to the invention because the manipulations and processes required to do so are reduced.

For example, trolleys such as those airline service trolleys used in airplanes for distributing food or products are conveyed on transport carriers according to the invention in a corresponding logistics center during the production process without requiring any additional manual operation in manual removal of a trolley from the transport carrier.

In another advantageous embodiment of a transport carrier according to the invention, the retaining structure has a mat with closed fluid-filled cavities.

For example, the mat may be made of a flexible polymer material, foamed or unfoamed.

The cavities in this material may be closed per se or they may be interconnected fluidically either partially or completely.

The cavities in the mat are especially advantageously filled with a high viscosity liquid, for example, a gel and/or non-Newtonian fluid.

Use of a high-viscosity fluid (viscosity 10²-10⁵ mPa s, advantageously 10³-10⁵ mPa s, especially advantageously 10⁴-10⁵ mPa s) has the advantage that the fluid is shifted and rearranged more slowly within a cavity and/or between cavities than is the case with a low viscosity fluid, so that deformation of the mat under the influence of a force is delayed. For example, if a rollable container is stored on such a mat, the mat adapts to the wheels of the container under the influence of the inherent weight of the rollable container. The rollable container sinks into the mat to a certain extent. If a horizontal force then acts briefly on the rollable container, for example, the centrifugal force with a change in direction on a horizontal conveyor system, then the wheels on the rollable container are secured in the recesses in the mat up to a certain maximum value of the acting horizontal force. Only when such a horizontal force acts on the container for a longer period does the high-viscosity fluid have enough time to flow into other cavities because of the application of force and thereby allow a horizontal displacement of the container, for example, during loading or unloading of the transport carrier.

One example of a suitable high-viscosity fluid is silicone oils which have a sufficient chain length to achieve the viscosity levels mentioned above. Silicone oils in particular have the advantage that they are chemically inert, nontoxic, no spoiling and nonflammable.

The fluid may also be a non-Newtonian fluid, in particular a dilatant, i.e., shear thickening fluid. Such fluids have a high viscosity under the influence of shear forces than in the absence of an applied force. When a horizontal force is applied to the container, the fluid becomes thickener and presents a greater resistance to any deformation.

One known example of a fluid having such properties is a concentrated suspension of starch in water or suitably crosslinked gels such as boron-crosslinked polygalactomannan gels.

In another advantageous embodiment of a transport carrier according to the invention, the retaining structure has an essentially closed container which contains a high-viscosity fluid, the container being sealed with a flexible wall on a side facing away from the transport carrier structure.

The high-viscosity fluid is in turn especially advantageously a gel and/or a non-Newtonian fluid. The aforementioned variants of the embodiment with a mat having cavities with high-viscosity fluid are also applicable similarly to this embodiment.

The flexible wall may advantageously be embodied as a polymer membrane.

In the aforementioned embodiments of a transport carrier according to the invention, flexible and/or rigid reinforcing elements which protect the flexible wall and/or the mat from mechanical effects are advantageously mounted on the surface facing away from the interior of the container of the flexible wall and/or the side of the mat facing away from the surface in the case of the aforementioned embodiments of a transport carrier according to the invention.

The reinforcing elements are especially advantageously designed as laminating elements or panel elements or grating elements. Such reinforcing elements result in a longer lifetime of the transport carrier.

In another advantageous embodiment of a transport carrier according to the invention, the retaining structure comprises recesses in a bearing surface.

With such a transport carrier, the retaining structure advantageously comprises a grating structure. Such a grating structure may be designed, for example, as a grating or as a plurality of parallel webs with recesses in between.

Alternatively, or additionally, with such a transport carrier the retaining structure may comprise a plurality of recesses in a planar bearing surface wherein the recesses are designed so that a segment of a wheel of a portable container can be arranged therein.

This means that the corresponding segment of the wheel is held in a form-fitting manner in the horizontal direction in the corresponding recess. For horizontal displacement of the rolling transport goods, a corresponding wheel on the transport goods must come out of the recess. Without any claim to accuracy of the explanation, this can be understood in simplified terms by explaining that to do so, the wheel must roll upward on a plane that is inclined by an angle α to the horizontal. To do so, the force component sin(α)F_{G} of the weight F_{G} acting at a right angle, wherein the force component is parallel to the fall line must be overcome. Thus, a corresponding opposing force must be overcome for displacement of the transport goods in the horizontal direction.

In the case of a transport carrier according to the invention, such as that discussed above, the transport carrier structure must have a peripheral edge protruding above the top side of the transport carrier structure. This allows a form-fitting fixation of the holding structure in the horizontal direction.

With a transport carrier according to the invention, the top side of the carrier structure may also be designed as a concave recess in which the transport goods can be arranged.

Such an embodiment is particularly advantageous for automated logistics processes with transport goods that can have very diverse shapes and forms, structures and dimensions. An example are luggage logistics processes of airports, where transport goods/luggage pieces of different kinds, for example hard-top cases, normal suitcases, flexible shipping bags, etc. have to be retrieved at the check-in counter, have to be subjected to a security check, and have to be correctly distributed to the different airplanes, or have to be unloaded from the airplanes and conveyed to the corresponding baggage claim areas or transfer flights, respectively. The existing logistics systems comprise various interfaces between different conveyor systems, for example belt conveyors and transport carts, which require manual handling. Furthermore, there is an increasing risk of mistakes. Particularly for large airports, such logistics systems are less efficient.

Said advantageous embodiment of a transport carrier with a concave recess allows form-fitting fixation of the transport good in the horizontal direction. At the same time, the transport good can be placed on the transport carrier and/or removed from the transport carrier with a rolling and/or sliding motion, without the transport goods becoming snagged or being damaged.

Alternatively, or additionally, the transport carrier may be temporarily pivoted in regard to the horizontal plane, for loading and/or unloading of the transport carrier. This enables the transport good to slide or roll out of the concave recess, driven by gravity, or it may be actively pulled out or rolled out.

Such a transport carrier can be conveyed not only along a horizontal axis. It may also be conveyed upwards or downwards on ramps with a certain inclination. The concave recess allows for a continuous adjustment of a temporary displacement of the transport good due to the inclination of the transport carrier. The maximum inclination that can be overcome is given by the requirement that at maximum inclination the transport good, driven by gravity, should not be able to roll or slide over the edge of the transport carrier.

For practical purposes, inclination angles for conveying paths will be chosen smaller than the maximum permissible value. To give an example, for an embodiment of a transport carrier as discussed further below in the context of FIG. 14 with loaded freely rollable transport trolley, the maximum permissible inclination degree is approx. 10°.

In practise, it is thus possible to realize conveying paths with inclination angles of 5° without difficulty, which allows to minimize costly structural measures for ensuring a constantly horizontal conveying path. For a transport carrier with a completely plane upper surface, however, such a conveyor inclination values would be very difficult to realize without uncontrollable displacements or movements of the rollable transport goods.

A concave recess may also be embodied as a double-concave recess, i.e., concave along both horizontal axes or as a bulge or protrusion or as a shell-type recess or a scoop-like recess or as an internal curvature.

The shape of the concave recess is advantageously selected so that the plane of the transport carrier develops steadily, i.e., without edges, into an oblique wall, at least in one direction. Therefore, parts of the transport goods, for example, the edges of pallet feet, cannot become tilted, snagged or caught.

The concave recess advantageously develops evenly into a peripheral edge of the transport structure.

In another advantageous variant of a transport carrier according to the invention, the bottom side of the transport carrier structure must be designed as a flat surface. This is advantageous for trouble-free conveyance of the transport carrier according to the invention on an automated conveyor system, for example, a belt conveyor, a link belt conveyor or a roller conveyor.

A flat bottom side of a transport carrier allows to turn the transport carrier in the horizontal plane. Thereby, also conveying systems may be applied on which the transport carriers do not have to be conveyed in a defined horizontal orientation, and on which they may rotate along the vertical axis, for example on a slowly moving link belt conveyor.

The bottom side is especially advantageously designed as a flat plate made of metal, plastic or wood, for example.

The bottom side may also advantageously be designed as a grating structure, which defines a flat supporting surface over the entire bottom side.

In the context of this description, a honeycomb structure is also understood to be a grating structure.

A grating structure allows a simpler design of the load-bearing structure of the transport carrier, for example, a greater supportable load.

The grating structure may be closed by a plate or a wall on the bottom side of the transport carrier or it may be open partially or completely to the outside, so that the edges of the grating structure serve as a supporting surface.

The grating structure may be made of a metal or a polymer material, for example.

Friction on the bottom side of the transport carrier is advantageously adapted to the corresponding conveyor system.

A transport carrier according to the invention may additionally also comprise other elements, which are used for handling of the transport carrier in an automated conveyor system or storage system.

A transport carrier according to the invention may be provided with an identification means that allows the identification of the transport carrier.

Such an identification means can comprise an RFID element, a barcode-element, a QR-code element and/or other means that can be readout by external reader devices, such as for example a RFID reader device, a barcode scanner or a camera.

A second aspect of the invention relates to an advantageous method for loading a transport carrier according to the invention. In such a method, a transport carrier according to the invention is provided in a loading position, in which the transport carrier is pivoted or pivoted by a certain angle in regard to a horizontal transport position. The transport good is also provided. The provided transport good is put on the provided transport carrier in the loading position, for example by sliding or rolling. The transport carrier is then pivoted into the horizontal transport position.

Advantageously, the transport carrier has a concave surface, and/or the surface of the transport carrier structure is formed as a concave recess, in which the transport good can be arranged.

Advantageously, the transport good can be moved in a rollable manner.

Advantageously, in the loading position of the transport carrier, the circumferential edge of the transport carrier is arranged flush to a plane on which the transport good is provided.

### BRIEF DESCRIPTION OF SEVERAL VIEWS OF THE DRAWINGS

For a better understanding of the present invention, reference is made below to the drawings, which show only exemplary embodiments of the subject matter of the invention.

FIG. 1 shows an embodiment of a transport carrier according to the invention.

FIG. 2 shows another embodiment of a transport carrier according to the invention.

FIG. 3 shows the embodiment of a transport carrier according to the invention from FIG. 2 with nonrollable transport goods placed thereon.

FIG. 4 shows the embodiment of a transport carrier according to the invention from FIG. 2 with rollable transport goods placed thereon.

FIGS. 5 through 10 show another embodiment of a transport carrier according to the invention.

FIG. 11 shows the transport carrier according to the invention with rollable transport goods according to FIG. 4 conveyed on a roller conveyor and placed on the transport carrier.

FIG. 12 shows the transport carrier according to the invention with rollable transport goods according to FIG. 5 placed on the transport carrier and conveyed on a belt conveyor.

FIG. 13A shows a cross-sectional view of another embodiment of a transport carrier having a concave recess according to the invention, with nonrollable transport goods mounted thereon, in a transport position.

FIG. 13B shows a cross-sectional view of another embodiment of a transport carrier having a concave recess according to the invention, with nonrollable transport goods mounted thereon, in a loading position.

FIG. 14 shows a cross-sectional view of another embodiment of a transport carrier having a concave recess according to the invention, with rollable transport goods mounted thereon.

FIG. 15 shows a cross-sectional view of the transport carrier from FIG. 14, with a suitcase positioned thereon.

FIG. 16A schematically shows in a cross-sectional view a method according to the invention, before loading a transport carrier with a transport good.

FIG. 16B schematically shows in a cross-sectional view a method according to the invention, during the loading process.

FIG. 16C schematically shows in a cross-sectional view a method according to the invention, after the completed loading process.

FIG. 16D schematically shows in a cross-sectional view a method according to the invention, during the unloading process.

FIG. 17 schematically shows a horizontal conveyor system with transport carriers according to the invention, which comprises sections with ramp portions.

### DETAILED DESCRIPTION OF THE INVENTION

The examples described below are intended to better illustrate the invention, but they are not suitable for restriction of the invention to the features disclosed herein. The same parts or those having the same effect are labeled with the same or similar reference numerals.

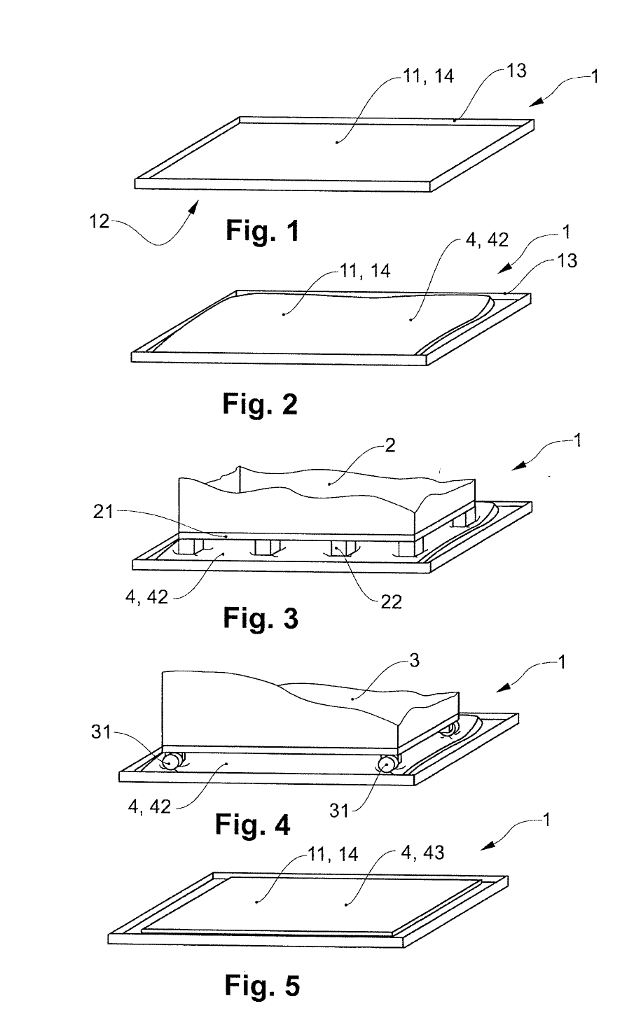

One possible embodiment of a transport carrier according to the invention is illustrated in FIG. 1. The transport carrier 1 comprises a flat bottom with a top side 11 and a bottom side 12, which is not visible here. The top side 11 defines the plane 14 of the transport carrier on which transport goods are stored during use of the transport carrier 1 as intended. The plane 14 of the transport carrier is bordered by an edge 13.

The structure of the bottom of the transport carrier device 1, which is diagramed schematically, is not shown in detail. Such a bottom may be embodied as a metal plate or sheet metal, for example.

The top side 11 of the transport carrier device 1 in the example shown here is provided with a coating as described further above, which increases the adhesive friction and rolling friction of rollable or nonrollable transport goods placed thereon. This coated top side 1 forms the holding structure 4 according to the independent claim in this case. For example, the top side 11 may be embodied as sheet metal coated with silicone rubber or acrylic rubber.

Another embodiment of a transport carrier according to the invention is diagramed schematically in FIG. 2. In the embodiment shown here, a gel mat 42 as a retaining structure 4 is arranged on the top side 11 of the transport carrier 1. In the example shown here the gel mat 42 is held in a form-fitting manner by the peripheral edge 13.

The gel mat 42 consists of al high viscosity gel, for example, a boron-crosslinked polygalactomannan in a mat-shaped bag. If transport goods are deposited on the gel mat 42, the transport goods will sink into the gel mat because of the deformation of the latter, resulting in a retaining force acting horizontally.

FIG. 3 shows the transport carrier 1 according to the invention from FIG. 2, loaded with nonrollable transport goods in the form of a pallet with eight block-type feet 22. The gel in the area is displaced laterally of the feet due to the pressure of the contact surface between the feet 22 and the gel mat 42, so that a bulge forms around these feet 22. This bulge of high viscosity gel presents a certain resistance to the feet 22 with a horizontal force acting on the transport goods, so that a certain force must be exceeded to overcome it.

FIG. 4 in turn shows the transport carrier from FIG. 2 loaded with rollable transport goods in the form of a transport container 3 equipped with four rolling elements 31. Here again, the rollers 31 on the transport container 3 sink into the gel mat 42 due to force of the weight acting on the mat and the transport container 3 is secured to prevent rolling displacement on the plane of the transport carrier.

FIG. 5 shows another embodiment of a transport carrier 1 according to the invention, in which the retaining structure 4 is designed as a foam rubber mat 43. As in the embodiment in FIGS. 2 to 4, the transport goods sink into the foam rubber mat 43 at the contact surfaces, which results in a high adhesive friction and/or a high rolling resistance. The transport goods are thus secured against horizontal displacement with respect to the transport carrier.

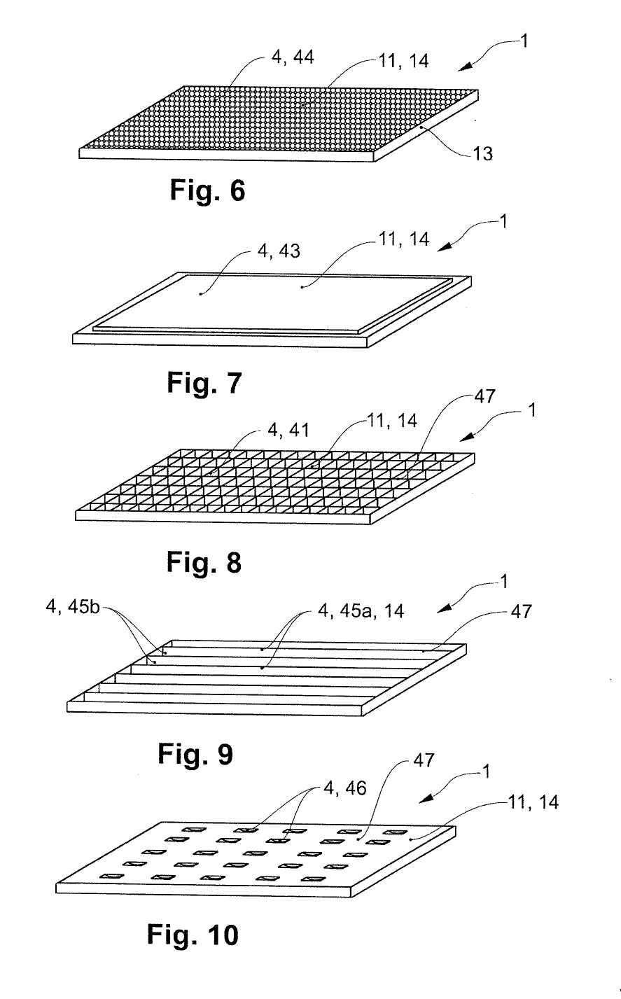

In the exemplary embodiment shown in FIG. 6, the retaining structure 4 of the transport carrier 1 is implemented as a brush mat 44. The length, density and stability of the brush fibers are selected so that the feet and/or the rollers on the transport goods cause local deformation in the brush mat, so that the transport goods again sink into the brush mat to a certain extent.

In the exemplary embodiments shown so far in FIGS. 2 to 6, the retaining structure 4 has been secured on the transport carrier 1 in a form-fitting manner due to the peripheral edge 13. FIG. 7 shows an embodiment of a transport carrier 1 without a peripheral edge but with a retaining structure 4 in the form of a foam mat 44. In this case the retaining structure 4 must be secured in some other way, for example, by adhesive, screw connection or form-fitting fixation in a corresponding recess in the surface of the transport carrier 1.

A transport carrier without a peripheral edge has the advantage that loading and/or unloading with portable auxiliary means or by rolling the rollable transport goods is/are simplified.

FIG. 8 also shows another possible embodiment of a transport carrier 1 according to the invention, in which the transport carrier is implemented as a grating structure 41. In addition to the mechanical stability of such a grating structure 41, the recesses in the grating structure result in the wheels and/or rollers of rollable transport carriers remaining in these recesses. Then there is only a certain lower segment of the wheels in the recesses, so that the rollable transport goods can be removed from the transport carrier with no problem. However, a certain horizontal force must be expended to accomplish this. Accordingly, the transport goods are secured against horizontal displacement on the transport carrier up to this threshold level.

Yet another embodiment of a transport carrier 1 according to the invention is shown in FIG. 9. The retaining structure 4 comprises a plurality of webs 45a arranged in parallel with recesses 45b situated between them. Such a retaining structure 4 may interact for example, with suitably shaped rollers on rollable transport goods such as shopping carts, for example, which are to be transported on inclined moving walkways for pedestrians.

These rollers comprising two hard tires spaced a distance apart from one another have a low rolling resistance on a flat surface. The distance between the tires of a roller is selected however so that the tires remain in the recesses 45b when the roller is positioned on the retaining structure 4.

Webs 45a then produce a braking action which can be achieved in several ways. For example, a cylinder made of an elastically deformable material which rests on one or more of the webs 45a situated between the tires may be arranged between the two tires of the roller, causing a great increase in the rolling resistance.

In another possible variant, the aforementioned webs 45a interact and activate a mechanism which reversibly brakes or blocks the roller. In this way a brake pad can be pressed against a roller axle by the webs, for example.

Up to a certain threshold level the rollable transport goods are thus secured against rolling displacement in the longitudinal direction of the webs 45a. Perpendicular to this the corresponding threshold level of the horizontal force is even higher.

Another embodiment of a transport carrier 1 according to the invention is diagramed schematically in FIG. 10. A plurality of recesses 46 forming the retaining structure 4 is arranged on the flat bearing surface 47 of the transport carrier.

The recesses 46 in the example shown here are arranged in a regular pattern so that the retaining structure 4 can be used for various types of rollable transport goods. For example, the distances between the recesses can be selected so that different types of airplane service trolleys with different wheel bases in the longitudinal direction and in the transverse direction can be deposited on the retaining structure 4.

The casters, wheels and/or rollers on the trolleys then sink into the recesses 46 to a certain extent. If the trolley is to be removed from the transport carrier, a certain force must be exerted in the horizontal direction to lift the trolley out of the recesses.

In the example shown here, the recesses are designed as elongated slots in the form of a segment of a circle. However, other shapes are also possible, for example, trough-shaped recesses or rectangular box-shaped recesses.

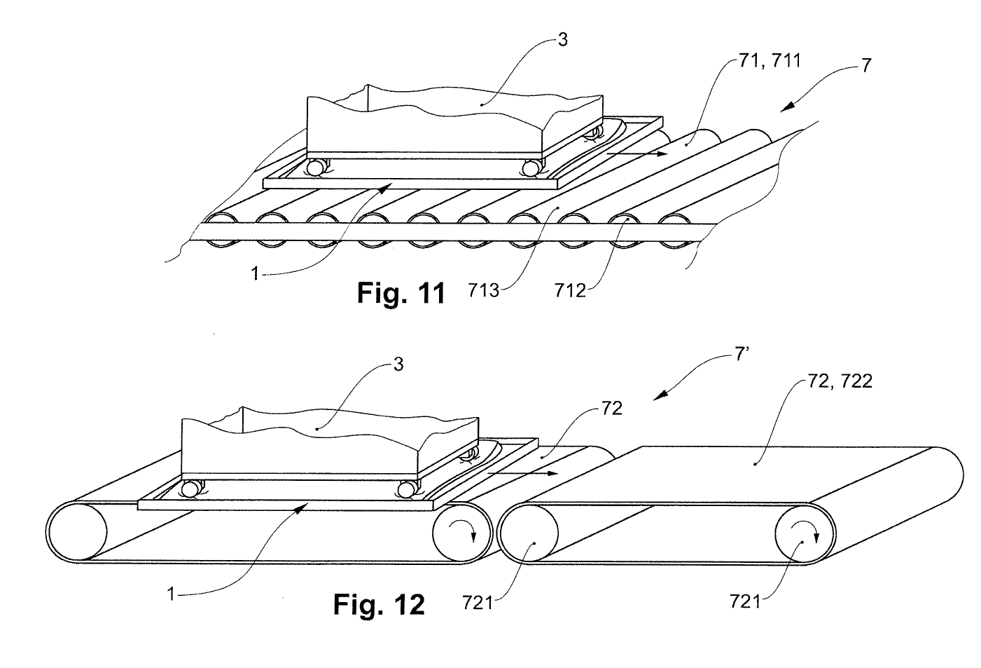

FIG. 11 shows as an example the use of a transport carrier 1 according to the invention on a horizontal conveyor system 7 in the form of a roller conveyor 71 comprising essentially a roller track 711 consisting of a plurality of rollers 712, each optionally being provided with an external roller shell 713. In an automated conveyor system, some or all of the rollers 712 are driven.

The conveyor goods are conveyed on the rollers, which are essentially rotating in the same direction and at the same speed, in a conveyor direction represented by the arrow in the figure. Traditional pallets having continuous feet in the longitudinal direction can be conveyed directly on such conveyor systems. However, if the transport goods have individual feet or rollers and/or wheels, then conveyance on a roller conveyor 71 will with a high probability result in damage to the feet and/or rollers or to damage to the conveyor system.

In the example shown here, this problem is solved by the fact that transport goods that are not directly conveyable as such are stored in the form of a trolley having four rollers on a transport carrier 1 according to the invention, as illustrated in FIG. 4. The transport carrier 1 rolls over the rollers of the conveyor system with no problem. The distance between the rollers here may be even greater than that in the example illustrated as long as the transport carrier 1 always rests with its bottom side on at least two to three rollers 712. A smaller number of rollers reduces the cost of al roller conveyor and is advantageous accordingly.

If the transport carrier is accelerated or decelerated on the roller conveyor and/or if it is guided around a curve, then horizontal forces act on the transport carrier and/or the transport goods stored on it. With a suitable design of the transport carrier however these forces will not exceed the threshold level so that the transport goods remain secured in the horizontal direction on the transport carrier.

FIG. 12 illustrates another example of an application. A transport carrier 1 according to the invention with rollable transport goods 3 supported thereon according to FIG. 4, is conveyed on a conveyor system 7′ in the form of a belt conveyor 72 with a belt 722 and rollers 721. The transport carrier 1 travels with no problem over gaps between belt conveyors 72 following one another. However, in the case of transport goods having feet or rollers, these may become trapped in the gap.

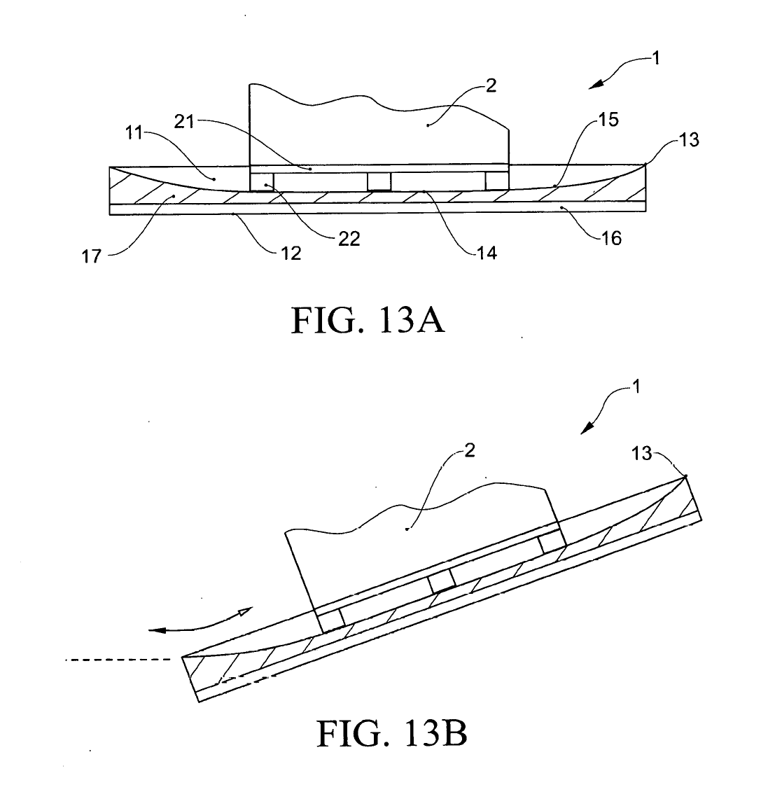

FIG. 13 illustrates another embodiment of a transport carrier 1 according to the invention. A holding structure 17 is arranged on a stable support structure 16 having a flat bottom side 12, which may be embodied as a metal plate or a grating. The holding structure 17 has a concave recess 15 which is open at the top. The holding structure 17 secures the transport goods to be transported, namely in the present case a non-rolling transport pallet 2 having a support structure 21 and feet 22, laterally. Thus, in the horizontal transport position of the transport carrier shown here [cf. FIG. 13(a)], the transport goods 2 cannot slide off the transport carrier during transport on the plane 14 of the transport carrier.

The concave shape of the holding structure is advantageously designed to be as smooth as possible, so that the transport goods cannot become skewed anywhere if the transport carrier is shifted out of the horizontal position [transport position in FIG. 13(a)] and into a tilted loading position, as shown in FIG. 13(b). The holding structure or at least the top side 11 of the holding structure 15 may be made of PTFE or HDPE, for example, or some other polymer having a low coefficient of friction.

In the unloading position, the transport pallet, under the force of gravity, will slide on the surface 11 down to the edge of the concave opening, or it can be pushed into this position by applying a low force. Alternatively, a loading device such as a pallet lifter (not shown), for example, can engage beneath the pallet at the side and lift the pallet up from the transport carrier 1 and/or deposit it on the transport carrier.

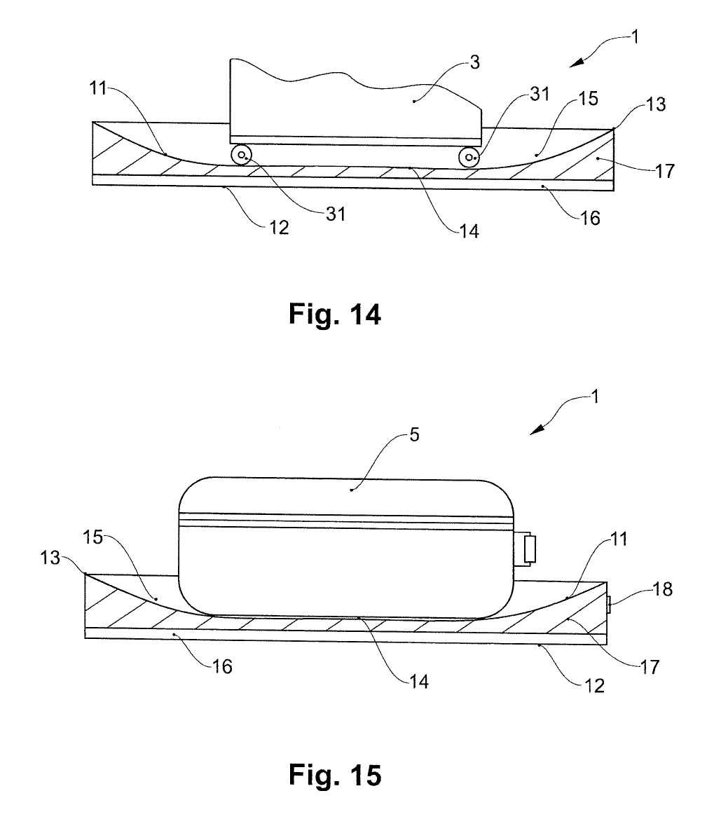

Another embodiment of a transport carrier 1 according to the invention is shown in the transport position in FIG. 14. A rolling transport container, for example, an airplane service trolley 3, is parked in the concave recess 15. The rollers 31 can be blocked with the usual means, such as parking brakes, for example. Alternatively, it is possible to omit blocking the wheels 31.

In particular at the relatively low transport speeds provided for the transport carriers 1 according to the invention, such additional means of securing the transport container 3 are not necessary. This has the advantage that it eliminates any manual step in loading and unloading the transport carrier 1. This allows more efficient labor processes and may even permit automation of the loading operation.

For example, a rolling transport container can be kept ready on an inclined plane, connected so that it is flush with the edge 13 of the transport carrier 1 in the horizontal transport position or in a tilted loading position, and it may advantageously have the same inclination as the surface 11 in the edge area of the recess 15. The transport container can then be shifted without significant effort by rolling it on the transport carrier, or it may roll automatically by the force of gravity on the transport carrier. Then the transport container is held securely in the transport position of the transport carrier.

For unloading, the transport carrier can be pivoted into an unloading position, in which the rolling transport container can be fetched by rolling it off of the transport carrier without applying a great force or it can roll away automatically by force of gravity on a plane connected to be flush with it.

The shaping of the holding structure is advantageously adapted to the type of transport goods provided and the type of loading and unloading. Thus, for example, with the transport carrier 1 in FIG. 14, the recess 15 is designed to be deeper, and thus the inclination of the surface 11 in the bordering area at the edge 13 is steeper with respect to the horizontal plane 14 of the transport carrier than in the embodiment of the transport carrier in FIG. 13.

Fully automatic loading and unloading of a transport carrier 1 according to the invention is particularly advantageous with objects for transport that have such a low center of gravity that they cannot be tilted over during loading and unloading under normal circumstances.

FIG. 15 shows the transport carrier 1 from FIG. 14 according to the invention, loaded with a suitcase lying horizontally. It can be brought automatically into the recess 15 of the transport carrier 1 via a slide under the force of gravity. Likewise, the suitcase 12 can be removed from the concave recess in the transport carrier by sliding it and sent for further processing by pivoting the transport carrier.

An identification means 18 is arranged on the transport carrier 1. The identification means 18 may comprise an RFID element, a barcode element or a QR code element and/or some other means which can be read out by an external reader. In this way, the transport carrier 1 can be identified unambiguously by corresponding detector devices, for example, an RFID reader, a barcode scanner or a camera.

Transport goods, for example, a baggage item, can be identified during loading, for example, by reading out a barcode label assigned to the baggage item at check-in, and can then be assigned to the proper transport carrier in a database of a controller.

The location of the transport carrier within a logistics system can be monitored easily by the identification means 18, so that the location of the transport goods is also always known.

Such an embodiment is particularly advantageous for transport, intermediate storage and commissioning of baggage items in automated intralogistics systems at major airports. Thus, for example, instead of using conveyor belts, baggage items can be received, conveyed, sorted, stored temporarily, gathered into groups, stored, commissioned, checked, x-rayed, dispensed or otherwise processed further on transport carriers according to the invention. Since the baggage items then always remain on the transport carriers according to the invention, only a minimum of manual steps is required. In particular, transfer operations and changing between different conveyance means can be reduced or avoided entirely. The transport goods are then exposed to less mechanical stress, which reduces the risk of damage.

Such highly automated processing of baggage items on transport carriers according to the invention increases safety and security because it minimizes possible access of potentially unauthorized persons to the transport goods. Accordingly, this also reduces the risk of theft, manipulations, etc.

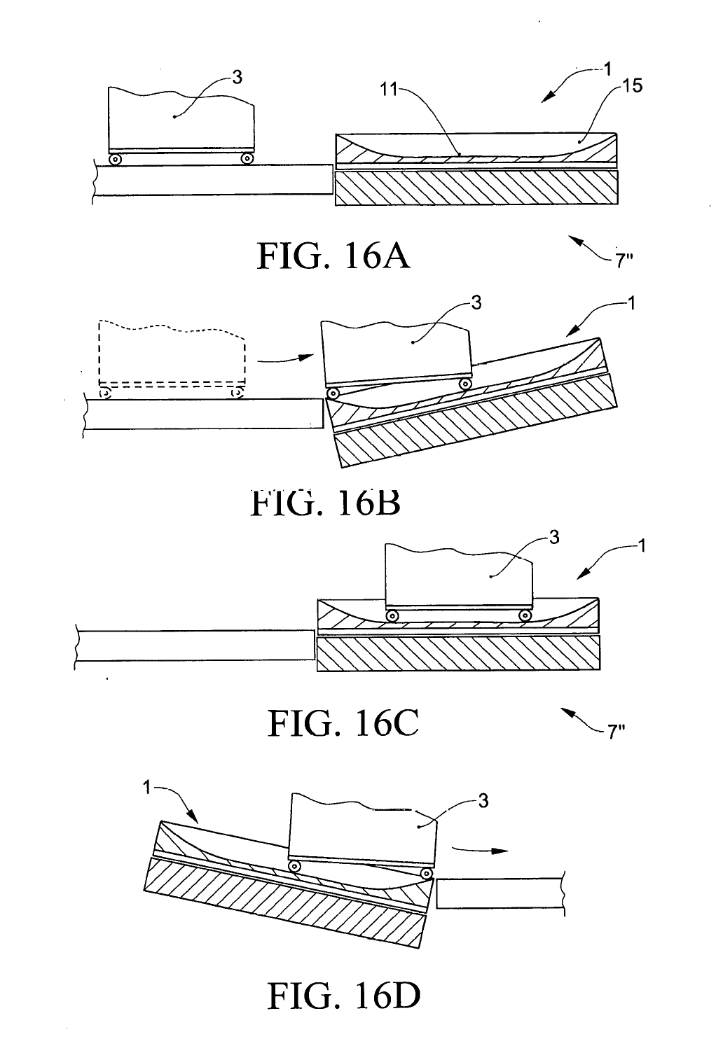

FIG. 16 shows individual intermediate steps of a method according to the invention. In FIG. 16(a), a rollable transport container 3 that must be loaded is furnished on a plane platform. Adjacent to the platform, a transport carrier 1 according to the invention with a concave recess 17 is located, still in its horizontal transport position, on a horizontal conveyor means 7″.

With a suitable actuator device, the transport carrier 1 is now pivoted to the left into a loading position, such that its edge is essentially flush to the rim of the platform on which the transport carrier 3 is provided [FIG. 16(b)]. The actuator device may for example be realized as a pivotable segment of the conveyor means, as in the shown example. The transport container can now be rolled to the right onto the transport carrier. This may be achieved manually by an operator, or automatically.

Instead of pivoting the transport carrier into the loading position just at the loading location, the pivoting movement can also take place during conveying on the conveyor means, by continuously changing the orientation of the conveyor means, for example a belt conveyor, along the conveying path, from a horizontal orientation into an orientation inclined transverse to the conveying path.

The dimensioning and shape of the transport carrier as well as the pivoting angle of the loading position are advantageously adapted to the dimensioning of the transport good, such that the transport trolley 3 stands stable on the transport carrier, as shown in FIG. 16(b).

Subsequently, the transport carrier 1 is pivoted to the right, back into the horizontal transport position [FIG. 16(c)]. This advantageously takes place at a pace that allows the transport trolley 3 to continuously roll into the position of the lowest potential energy, driven by gravity, such that the transport container always stands stable and essentially upright.

Finally, the transport container 3 stands on the plane, middle area of the transport carrier 1 in its horizontal transport position, as shown in FIG. 16(c). The transport carrier can now be conveyed further, as needed, or can be handled in other ways in a logistics system.

The unloading of the transport carriers can take place in a way similar to the loading of the transport carriers [FIG. 16(d)]. The transport carrier 1 is pivoted, in the shown example to the right. This advantageously takes place at a pace that allows the rollable transport container 3 to continuously remain in a stable condition and essentially upright.

Finally, the transport carrier 1 reaches the unloading position as shown in FIG. 16(d), in which the right edge of the transport carrier is essentially flush to a plane platform adjacent to it on the right. The transport container may then be retrieved manually or automatically, in a rolling manner.

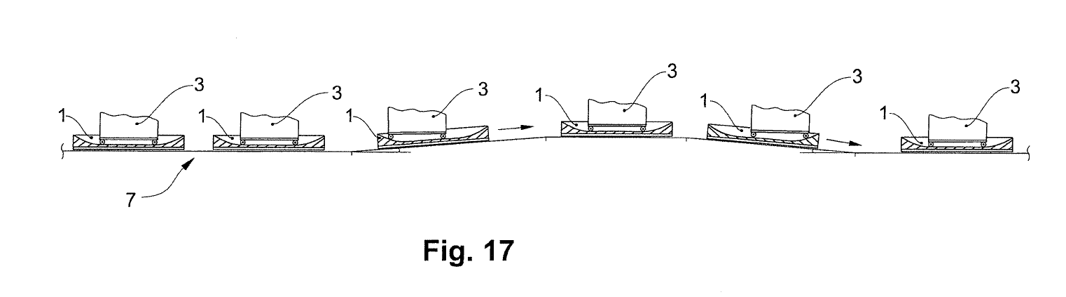

A horizontal conveyor system 7 with a multitude of transport carriers 1 according to the invention with transport goods 3 is depicted in FIG. 17. The schematically shown transport carriers 1 comprise a concave recess, for example similar to FIG. 14. The transport goods are rollable container such as airplane service trolleys.

The conveyor system 7, for example a slowly travelling belt conveyor, moves the transport carriers 1 placed on the belt conveyor from the left to the right. After a horizontal section of the conveying path follows an upward ramp, with an exemplary inclination of 8% (approx. 5°). After a further horizontal section and a downward ramp with an 8% decline follows a further horizontal stretch.

While the inclination of the transport carriers 1 along the conveying path corresponds to the corresponding inclination of the conveyor system 7, the freely rolling transport trolleys 3 compensate the inclination. The transport trolleys automatically displace gravitationally driven on the concave upper surface of the transport carrier into a position in which the potential energy is locally minimum, and in which the transport container remains essentially perpendicular.

With such a system, positive and negative inclinations in wide-stretching logistics sites can be overcome without dedicated vertical lifting means. For example, differences in height of levels in different buildings can be overcome, or between two levels of the same building, without the need for expensive lift devices or the like.

The present invention is not limited in scope to the specific embodiments described here. Instead various other modifications of the present invention, which also fall within the protective scope of the claims are also derived from the description and the respective figures for those skilled in the art, in addition to the examples disclosed here. Furthermore, the description cites various references, whose disclosure content is herewith included in its entirely in the present description through reference thereto.

It is claimed:

1. A transport carrier (1) for transport of transport goods, comprising:
a transport carrier structure for carrying the transport goods (2, 3, 5) on a horizontal plane (14) of the transport carrier, having a top side (11), which defines the plane of the transport carrier, and a bottom side (12); and
a retaining structure (4) arranged on the top side of the transport carrier structure for restricting or preventing a horizontal movement of transport goods supported on the transport carrier structure with respect to the plane of the transport carrier;
wherein the retaining structure has means (41, 42, 43, 44, 45a, 45b, 46) which interact with bearing elements (22, 31) of the aforementioned transport goods standing on the transport carrier structure and thus cause a reversible fixation of the transport goods along at least one vector parallel to the plane of the transport carrier, such that a force exceeding a certain threshold level must be expended parallel to the plane of the transport carrier to overcome said fixation.

2. The transport carrier according to claim 1, wherein the retaining structure (4) comprises means which increase the adhesive friction with respect to a smooth surface.

3. The transport carrier according to claim 1, wherein the top side (11) of the transport carrier structure is at least as large as or larger than the projection of transport goods (2, 3, 5) supported on the transport carrier structure perpendicular to the plane (14) of the transport carrier.

4. The transport carrier according to claim 1, wherein the retaining structure (4) secures in a non-form-fitting way and/or can secure in a non-form-fitting manner transport goods (2, 3, 5) supported on the transport carrier structure parallel to the plane (14) of the transport carrier.

5. The transport carrier according to claim 1, wherein the retaining structure (4) comprises at least one of: a coating with a polymer having a high adhesive friction, a mat made of an elastic polymer, a brush mat, a mat having cavities, a carpet or combinations thereof.

6. The transport carrier according to claim 1, wherein the retaining structure (4) comprises a mat with closed fluid-filled cavities.

7. The transport carrier according to claim 1, wherein the retaining structure (4) comprises an essentially closed container which contains a high-viscosity fluid and is closed with a flexible wall on a side facing away from the transport carrier structure.

8. The transport carrier according claim 6, wherein flexible and/or rigid reinforcing elements which protect the flexible wall and/or the mat from mechanical influences are mounted on the surface of the flexible wall facing away from the container interior and/or the side of the mat facing away from the surface (11).

9. The transport carrier according to claim 8, wherein the reinforcing elements are tile elements or panel elements or grating elements.

10. The transport carrier according to claim 1, wherein the retaining structure (4) comprises recesses (45b, 46) in a bearing surface (47).

11. The transport carrier according to claim 10, wherein the retaining structure (4) comprises a grating structure.

12. The transport carrier according to claim 10, wherein the retaining structure comprises a plurality of recesses (46) in a plane or bearing surface (47), wherein the recesses are designed so that a segment of a wheel (31) of a portable container can be arranged therein.

13. The transport carrier according to claim 1, wherein the transport carrier structure has a peripheral edge (13) which protrudes above the top side (11) of the transport carrier structure.

14. The transport carrier according to claim 1, wherein the surface (11) of the support structure is designed as a concave recess (15), in which the transport goods (2, 3, 5) can be arranged.

15. The transport carrier according to claim 13, wherein the concave recess (15) includes a flush transition to a peripheral edge (13) of the transport structure.

16. The transport carrier according to claim 1, wherein the bottom side (12) of the transport carrier structure is designed as a planar surface.

17. The transport carrier according to claim 1, wherein the bottom side (12) is designed as a grating structure which defines a planar supporting surface over the entire bottom side.

18. A method for loading a transport carrier, comprising the steps:
providing a transport carrier (1) according to claim 1 in a loading position, in which the transport carrier is pivoted by a certain angle in regard to a horizontal transport position;
providing a transport good (3);
putting the provided transport good on the provided transport carrier in the loading position;
pivoting the transport carrier into the horizontal transport position.

19. The method according to claim 18, wherein the transport carrier (1) includes a concave surface, and/or is a transport carrier wherein the surface (11) of the support structure is designed as a concave recess (15), in which the transport goods (2, 3, 5) can be arranged.

20. The method according to claim 18, wherein the transport good (3) can be moved in a rollable manner.
